(19) United States
(12) Patent Application Publication
(10) Pub. No.: US 2011/0287674 A1
(43) Pub. Date: Nov. 24, 2011

(54) Watercraft propulsion device

(75) Inventor: Thomas Jemt, Broma (SE)

(73) Assignee: Dolprop Industries AB, Stockholm (SE)

(21) Appl. No.: 12/998,810

(22) PCT Filed: Dec. 18, 2009
(86) PCT No.: PCT/EP2009/067469

§ 371 Date: Aug. 10, 2011

(30) Foreign Application Priority Data
Dec. 23, 2008 (EP) 08172675.4

(51) Int. Cl. B63H 1/36; F16M 13/02; B63H 16/20; B63H 16/00; B63H 16/08

(52) U.S. Cl. 440/15; 248/674

(57) ABSTRACT

A propulsion device is disclosed for propelling a floating watercraft. In at least one embodiment, the propulsion device includes a flexible fluke that is pivotal about a substantially horizontal fluke pivot axis, and at least one device for transmitting an oscillatory motion about the fluke pivot axis to the fluke. The propulsion device may be reconfigured between two or more modes or combinations of modes, for example: a manual power mode, in which a hand-lever is mechanically engaged with the fluke for transmitting an oscillatory, propulsive motion to the fluke by way of a reciprocating movement of the hand-lever; a motor-powered mode, in which a motor is mechanically engaged with the fluke, and the motion of the hand-lever is isolated from any propulsive motion of the fluke about the fluke pivot axis; a forward mode, in which a main portion of the fluke extends astern of the pivot axis; and a reverse mode, in which a main portion of the fluke extends afore of the fluke pivot axis.

### FIELD OF THE INVENTION

The present invention relates to a propulsion device for propelling a floating watercraft, the propulsion device comprising a flexible fluke that is pivotal about a substantially horizontal fluke pivot axis, and a motor or other means for transmitting an oscillatory motion to the fluke.

### BACKGROUND OF THE INVENTION

WO2008123815 (A1) discloses a propulsion device for propelling a floating watercraft, the propulsion device comprising a flexible fluke that is pivotal about a substantially horizontal fluke pivot axis. The fluke is powered by a motor, which transmits a motion to the fluke via a reduction gear, and via a crank shaft for converting the rotary motion of the motor to an oscillatory motion of the fluke.

The propulsion device of WO2008123815 (A1) comprises an impeller, which is capable of directing a jet of water in the forward direction of the watercraft for reducing the speed of the watercraft, or for propelling the watercraft in the reverse direction. The impeller has a water inlet, which may be blocked in case there is a lot of debris, such as plastic sheet, floating in the water. Any debris may get sucked into the inlet and block it, and thereby limit the watercraft's ability to stop, and to reverse.

Further, with the device of WO2008123815 (A1), as well as with any small boat having an outboard engine, it is a recommended precaution to have a pair of oars or a paddle, and distress signal rockets, available in the boat in case one runs out of fuel or battery power.

### SUMMARY OF THE INVENTION

It is an object of the present invention to solve, or at least mitigate, parts or all of the above mentioned problems. To this end, there is provided a propulsion device for propelling a floating watercraft, the propulsion device comprising a flexible fluke that is pivotal about a substantially horizontal fluke pivot axis, and a motor for driving the fluke. The propulsion device is adapted to be set in a manual power mode, in which a hand-lever is mechanically engaged with the fluke for transmitting an oscillatory, propulsive motion to the fluke by means of a reciprocating movement of the hand-lever, and in a motor-powered mode, in which the motor is mechanically engaged with the fluke, and the motion of the hand-lever is isolated from any propulsive motion of the fluke about said fluke pivot axis. Thanks to the reconfigurability between the two modes, the consequences of running out of fuel or battery are reduced. Further, by isolating the motion of the hand-lever from the motion of the fluke in the motor-powered mode, it is possible to safely switch the propulsion device from a manual mode to a motor-powered mode, without the risk of an operator getting injured by the hand-lever.

In one embodiment, the propulsion device comprises a lower propulsion link, from which the fluke extends, and an upper control link, said propulsion link and said control link being interconnected by a first vertical link and a second vertical link, said first and second vertical links being connected to said control link and said propulsion link in pivot joints. This embodiment allows for a particularly simple transmission from the motor to the fluke.

In another embodiment, the propulsion device comprises a lower propulsion link, from which the fluke extends rearwards, and an upper control link, said propulsion link and said control link each having the shape of a wheel, and being interconnected by a drive chain or a drive belt. This embodiment reduces the number of pivot joints that need to be greased or otherwise maintained.

In one preferred embodiment, said hand-lever is configured to be releasably attached to said control link. This is a particularly reliable way of isolating its motion from the oscillating motion of the fluke.

In another embodiment, at least one of said pivot joints is reconfigurable from a pivotal state to a rigid state. This is a particularly simple way of isolating the motion of the hand-lever from the oscillating motion of the fluke.

In yet another embodiment, the propulsion device is also adapted to be set in a forward mode, in which a main portion of the fluke extends astern of the fluke pivot axis, and in a reverse mode, in which a main portion of the fluke extends afore of the fluke pivot axis.

According to another aspect of the invention, parts or all of the above mentioned problems are solved, or at least mitigated, by a propulsion device for propelling a floating watercraft, the propulsion device comprising a flexible fluke that is pivotal about a substantially horizontal fluke pivot axis, and means for transmitting an oscillatory motion about said fluke pivot axis to said fluke. The propulsion device is adapted to be set in a forward mode, in which a main portion of the fluke extends astern of the fluke pivot axis, and in a reverse mode, in which a main portion of the fluke extends afore of the fluke pivot axis. Thanks to the invention, it is possible to use the fluke for reducing the forward speed of the watercraft, and for propelling the watercraft in a reverse direction, thereby eliminating the need for an impeller. Compared to an impeller, a fluke is very unlikely to be damaged by debris in the water.

Preferably, the propulsion device is arranged to be reconfigured from said forward mode to said reverse mode by turning the fluke about a substantially horizontal fluke reversal axis. This design is not very dependent of how the propulsion device is attached to the watercraft.

In a preferred embodiment, the propulsion device further comprises a lower propulsion link, from which the fluke extends, and an upper control link, said propulsion link and said control link being interconnected by a first vertical link and a second vertical link, said first and second vertical links being connected to said control link and said propulsion link in pivot joints, wherein the propulsion device is arranged to be reconfigured from said forward mode to said reverse mode by turning said control link about a substantially horizontal control link axis, such that the fluke is turned about said substantially horizontal fluke reversal axis. This design makes it very easy for an operator to turn the fluke, without requiring that any manoeuvre be performed underwater. More preferably, the watercraft propulsion device further comprises a support link, which supports a fluke pivot joint that coincides with said fluke reversal axis and said fluke pivot axis. The support link minimizes the risk that the first vertical link is crossed with the second vertical link, when switching between a forward mode and a reverse mode.

In another embodiment, the propulsion device comprises a lower propulsion link, from which the fluke extends rearwards, and an upper control link, said propulsion link and said control link each having the shape of a wheel, and being interconnected by a drive chain or a drive belt. This embodiment reduces the number of pivot joints that need to be greased or otherwise maintained.

The watercraft propulsion device preferably comprises a transom bracket for removably installing the propulsion device to the transom of a floating watercraft.

The term “fluke” is intended to cover any type of propulsion fin extending mainly in the horizontal plane, and being intended for moving in the vertical direction, or turning about a horizontal axis, in an oscillating manner.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a diagrammatic view in perspective of a watercraft propulsion device in a forward motor-powered mode;

FIG. 2a-c are diagrammatic views in perspective of the propulsion device of FIG. 1, each view having different parts broken away;

FIG. 3 is a diagrammatic view in perspective, with parts broken away, of the propulsion device in an intermediate position between a forward and a reverse motor-powered mode;

FIG. 4 is a diagrammatic view in perspective, with parts broken away, of the propulsion device in a reverse motor-powered mode;

FIG. 5 is a diagrammatic view in perspective, with parts broken away, of the upper unit of the propulsion device in a forward manual power mode;

FIG. 6 is a diagrammatic view in perspective, with parts broken away, of a second embodiment of a watercraft propulsion device; and

FIG. 7 is a diagrammatic view in perspective of a third embodiment of a watercraft propulsion device.

### DETAILED DESCRIPTION OF THE EXEMPLARY EMBODIMENTS

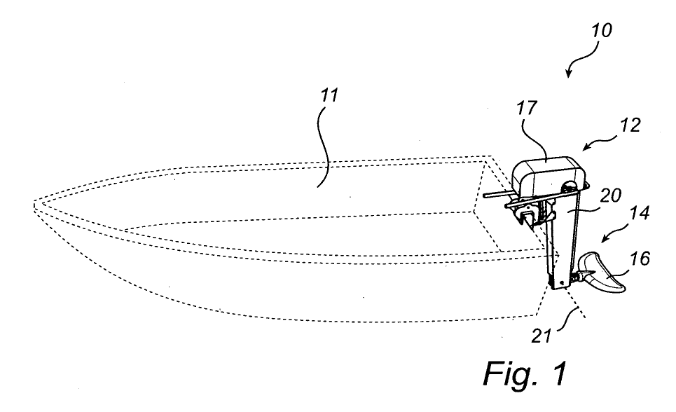

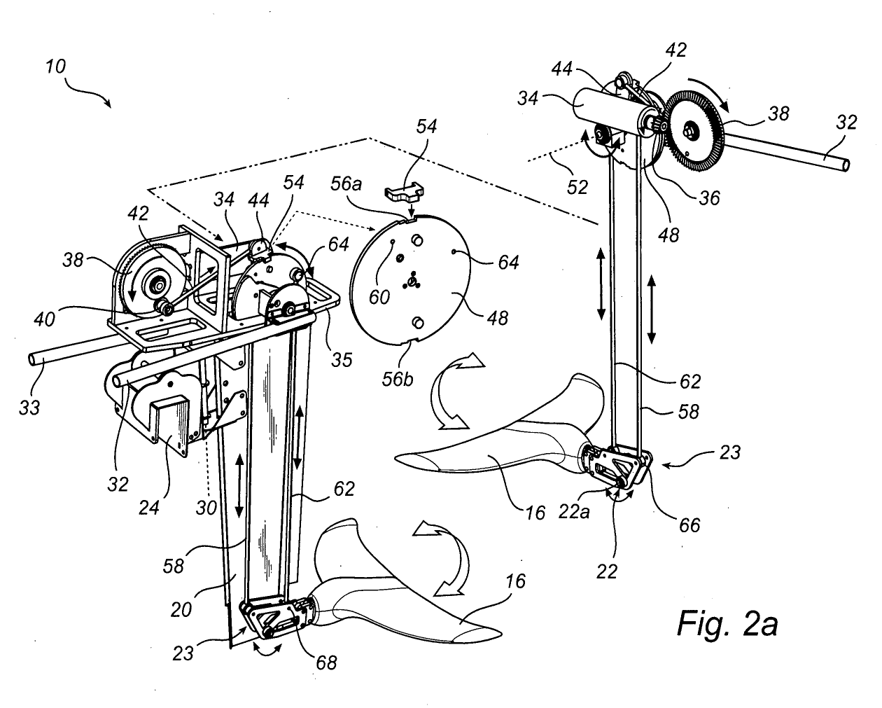

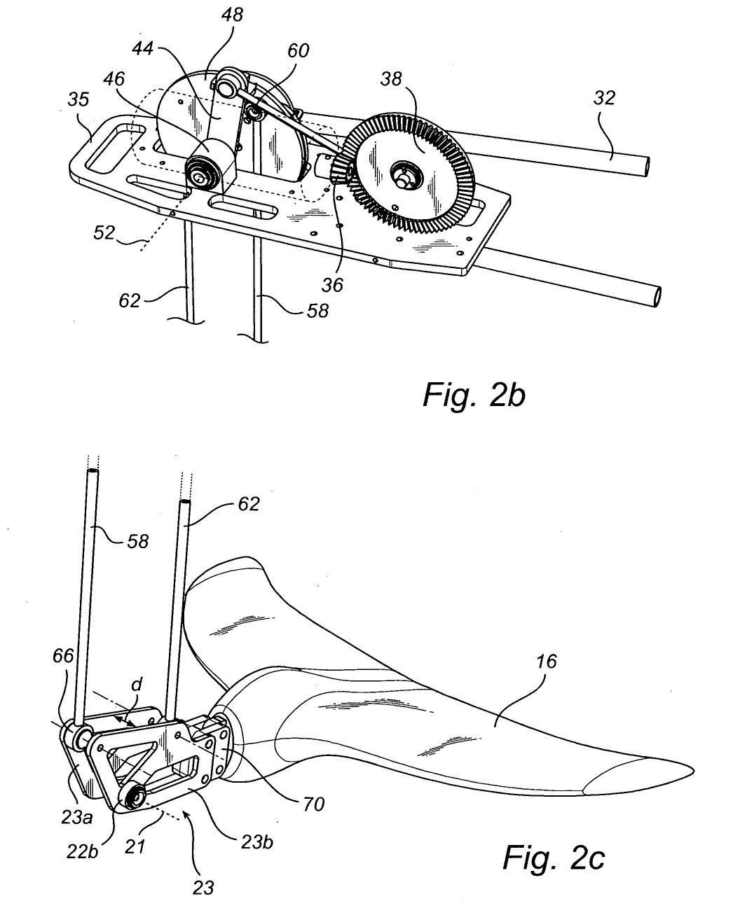

FIG. 1 illustrates a watercraft propulsion device 10 mounted on the transom of a small boat 11. The watercraft propulsion device has an upper unit 12 comprising drive means, and a lower unit 14 comprising a propulsion fluke 16. An upper unit cover 17 encases the drive means. Transmission means, for transmitting power from the drive means to the fluke 16, extend from the upper unit 12 to the lower unit 14, and are encased in a transmission housing 20. The transmission housing 20 also acts as a support link, which supports a fluke pivot joint 22 (FIG. 2), in which a propulsion link 23 (FIG. 2) is pivotally journalled. The fluke 16 is connected to the propulsion link 23, and is thereby arranged to pivot about a fluke pivot axis 21 defined by the fluke pivot joint 22.

FIGS. 2a-c illustrate the propulsion device 10 of FIG. 1 in more detail. In FIGS. 2a-c, the watercraft propulsion device 10 is set in a forward motor-powered mode. For reasons of clarity, the upper unit cover 17 and one side of the transmission housing 20 are broken away in FIG. 2a. The figure also illustrates particular details of the propulsion device 10 separately. The upper unit comprises an electric motor 34, which is attached to a frame 35. The transmission housing 20 is rigidly attached to the frame 35, and pivotally connected to a transom bracket 24 such that it may be pivoted about a substantially vertical axis 30. In this manner, the propulsion device 10 may be removably installed to the transom of a watercraft 11 (FIG. 1), and the direction of the fluke's 16 thrust may be changed by an operator (not shown) by swiveling the propulsion device 10 about the axis 30 using a hand-lever 32, or a tiller 33.

The electric motor 34 is configured to transmit a rotary motion via a first bevel gear 36 to a second bevel gear 38. The bevel gears 36, 38 have the two functions of performing gear reduction of the rotary motion of the electric motor 34, and changing the axis of rotation of the rotary motion transmitted by the motor 34. The second bevel gear 38 is provided with a crankpin 40, and thereby also acts as a crank shaft. A first end of a connecting rod 42 is pivotally connected to the crankpin 40, and a second end of the connecting rod 42 is pivotally connected to a first end of rocker 44. The rocker 44 has a second end that is pivotally journalled in a rocker bearing 46 (FIG. 2b) that is attached to the frame 35. The crankpin 40 and the connecting rod 42 thus operate so as to transmit the rotary motion of the second bevel gear 38 to a reciprocating motion of a connecting rod 42, which is configured to reciprocate the rocker 44.

The rocker 44 is arranged to be releasably connected to a control link 48, which forms part of a transmission linkage 50 for transmitting a reciprocating motion to the fluke. The control link 48, which is in this particular embodiment shaped as a wheel, is pivotally journalled about a control link pivot axis 52 in a control link journal bearing (not shown), which is carried by the frame 35. The control link pivot axis coincides with the pivot axis of the rocker bearing 46. A rocker latch 54, shown in FIG. 2a, is attached to the first end of the rocker 44, and is configured to releasably attach the first end of the rocker 44 by snapping into a first notch 56a in the periphery of the control link 48. In this manner, a reciprocating motion of the rocker 44 about the rocker bearing 46 may, by engaging the rocker 44 with the control link 48 using the rocker latch 54, be transmitted to an oscillating motion of the control link 48 about the control link pivot axis 52.

An upper end of a rigid, substantially vertical first drive link 58 is pivotally connected to the control link 48 at a first upper link pivot joint 60, which is located on a first side of the control link 48, at a distance from the pivot axis 52 of the control link 48. A rigid, substantially vertical second drive link 62 is pivotally connected to the control link 48 at second upper link pivot joint 64, which is located on a second side of the control link 48, at a distance from the pivot axis 52 of the control link 48. The two drive links 58, 62 are parallel and of essentially the same length.

A lower end of the first drive link 58 is, as is shown in FIG. 2c, pivotally connected to the propulsion link 23 at a first lower link pivot joint 66, which is located at a distance from the pivot axis 21 of the fluke pivot joint 22. A lower end of the second drive link 62 is pivotally connected to the propulsion link 23 at a second lower link pivot joint 68, which is also located at a distance from the pivot axis 21 of the fluke pivot joint 22. An oscillating motion of the control link 48 about the control link pivot axis 52 will thereby be transmitted, via the two drive links 58, 62, to an oscillating motion of the propulsion link 23 about the fluke pivot axis 21, which will result in an oscillatory, or reciprocating, motion of the fluke 16 in a vertical direction, as is indicated by arrows in FIG. 2a.

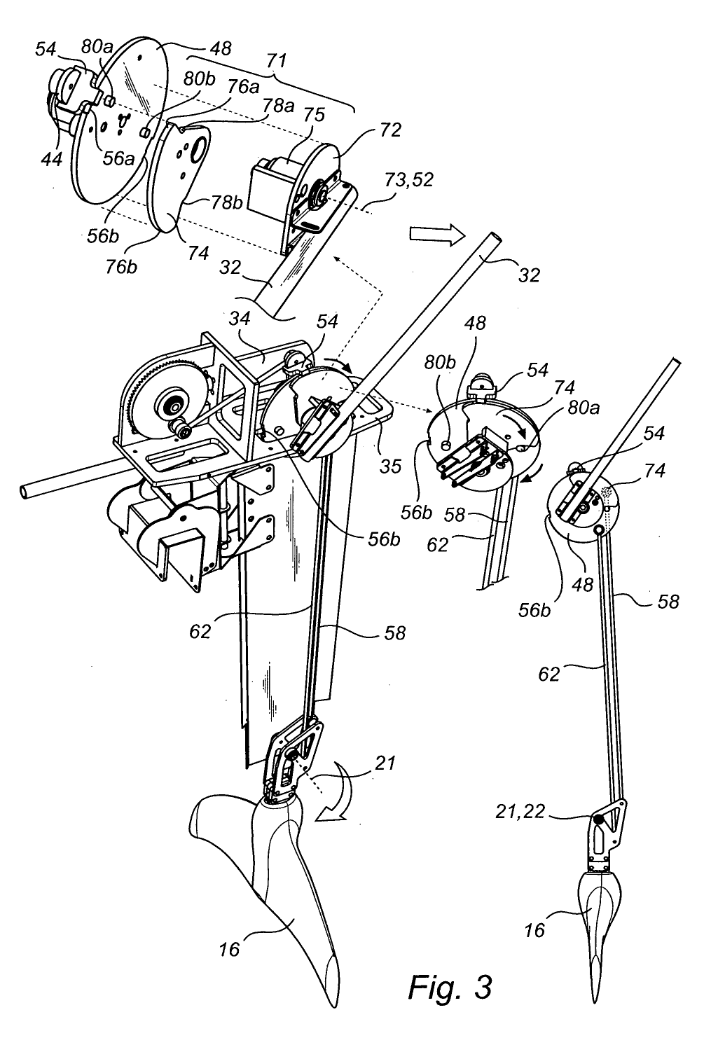

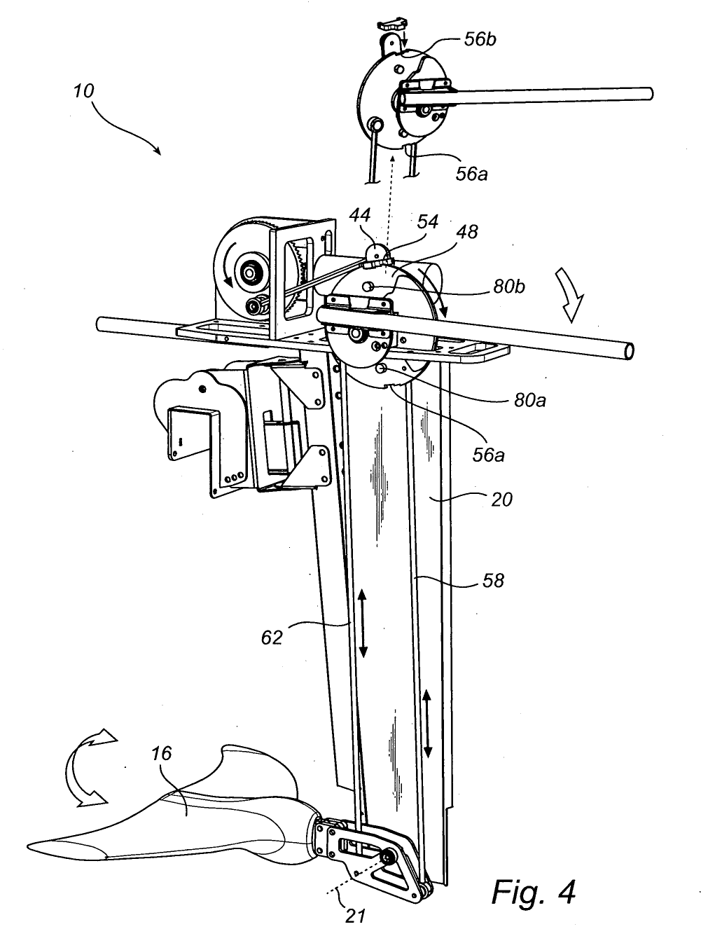

FIG. 2c shows the lower unit of the propulsion device 10 in more detail. The propulsion link 23 comprises a first propulsion link side part 23a, and a second propulsion link side part 23b. The two propulsion link side parts 23a-b are separated by a distance d, and connected to and separated from each other by a fluke bracket 70. Thereby, the propulsion link 23, together with the fluke bracket 70, form a U-shape as seen from below, and define an opening. A first and a second leg of the U-shape are formed by the first and second propulsion link side parts 23a-b, and the open end of the U faces the opposite side of the fluke 16, i.e. the forward direction of the watercraft 11 in FIG. 1. The first drive link 58 is pivotally connected to the first propulsion link side part 23a in said first lower link pivot joint 66, which is located on an inner side of the first leg of the U. The second drive link 62 is pivotally connected to the second propulsion link side part 23b in said second lower link pivot joint 68, which is located on an inner side of the second leg of the U. Further, the fluke pivot joint 22 consists of two separate bearings, i.e. of a first fluke pivot joint bearing 22a (FIG. 2a), and a second fluke pivot joint bearing 22b (FIG. 2c). The first and second fluke pivot joint bearings 22a-b, being located on the outer sides of the propulsion link side parts 23a-b, pivotally connect the first and second propulsion link side parts 23a-b to the transmission housing 20, while leaving the opening inside the U-shape unobstructed. The inner distance d between the two propulsion link side parts 23a-b is large enough to allow the second drive link 62 to pass the pivot joint 66 of the first drive link 58, when the propulsion link 23 is turned about the fluke pivot joint 22 in the manner described below with reference to FIGS. 3-4.

Now referring to FIG. 3, the propulsion device 10 is capable of being switched between a forward mode and a backward mode using the hand-lever 32, which forms part of a hand-lever assembly 71. The hand-lever assembly 71 comprises an outer guide washer 72 and an inner switching cam 74, which are rigidly connected to the hand-lever 32. Even though the switching cam 74 in the figure is shown disassociated from the guide washer 72, the two parts are in fact rigidly attached to each other. The hand-lever assembly 71 is pivotally connected to the frame 35 by means of a hand-lever assembly journal bearing 75. The pivot axis 73 of the hand-lever assembly 71 coincides with the pivot axis of the rocker 44, and with the pivot axis 52 of the control link 48. The switching cam 74 has the general shape of a sector of a circular disc having the same diameter as the disc-shaped control link 48, and is located adjacent to the control link 48. As a consequence, a portion of the camming edge of the switching cam 74 is aligned with the periphery of the control link 48. However, a first lifter portion 76a and a second lifter portion 76b of the camming edge of the switching cam 74 are bevelled.

An operator (not shown) may switch from the forward mode (FIG. 1-2) to the reverse mode (FIG. 4) by turning the hand-lever assembly 71 in a first direction (illustrated with an arrow in FIG. 3) about the hand-lever assembly pivot axis 73 by means of the hand-lever 32. By doing so, the first lifter portion 76a of the switching cam 74 will lift the rocker latch 54 from its position inside the first notch 56a in the periphery of the control link 48. Thereby, the control link 48, and consequently also the fluke 16, will be disengaged from the rocker 44, and from the motor 34. Continuing the turning of the hand-lever assembly 71 in said first direction about the pivot axis 73, a first catch edge 78a of the switching cam 74 will abut against a first dog 80a of the control link 48, and force the control link 48 to turn about the control link pivot axis 52 in said first direction. Thereby, the drive links 58, 62 will force the propulsion link to turn about the fluke pivot axis 21. When the control link 48 has turned approximately 180° about the control link pivot axis 52, the rocker latch 54 will engage with a second notch 56b in the periphery of the control link 48, as illustrated in FIG. 4. The second notch 56b is located in the opposite edge of the control link 48, relative to the first notch 56a.

Instead of manually, using the hand lever 32, turning the control link 48 all the 180° from a position in which the rocker latch 54 engages with the first control link notch 56a to a position in which the rocker latch 54 engages with the second control link notch 56b, it is also possible to turn it manually e.g. 160°, and then operate the motor 32. The rocker 44 will then slide the rocker latch 54 along the periphery of the control link 48, until the latch 54 “finds” the notch 56a, and engages with it.

FIG. 4 illustrates this position of the control link 48 and the rocker latch 54, when the propulsion device 10 has been reconfigured from a forward mode (FIGS. 1-2), via an intermediate position (FIG. 3) to a reverse mode (FIG. 4).

Having reached this position, also the fluke 16 will have turned approximately 180° about the fluke pivot axis 21, and will have reached the reverse position illustrated in FIG. 4. The fluke pivot axis 21 thereby also acts as a fluke reversal axis. In the reverse mode illustrated in FIG. 4, the fluke 16 extends generally afore, i.e. in the normal direction of travel of a watercraft carrying the watercraft propulsion device 10. A reciprocating motion of the rocker 44 will, in the same manner as in the forward mode described hereinbefore with reference to FIGS. 1-2, transmit to an oscillating motion of the fluke 16 about the fluke pivot axis 21. However, the thrust of the watercraft propulsion device 10 will have an opposite direction, compared to the forward mode of FIGS. 1-2. In this manner, the watercraft propulsion device 10 can not only be used for propelling the watercraft 11 (FIG. 1) in a forward direction, but also be used for reducing the forward speed, or for propelling the watercraft 11 in a reverse direction.

By lifting the hand-lever 32 somewhat after having reversed the fluke 16, so that the first catch edge 78a of the switching cam 74 does no longer abut against the first dog 80a but leaves a sufficient clearance, the oscillating motion of the control link 48 about the control link pivot axis 52 will not be transmitted to the hand-lever 32. This is the position of the hand-lever 32 that is illustrated in FIG. 4.

In order to switch from the reverse mode illustrated in FIG. 4 to the forward mode illustrated in FIGS. 1-2, the hand-lever assembly 71 (FIG. 3) is turned about its pivot-axis 73 in a second direction, which is opposite to the first direction that is illustrated with the arrow in FIG. 3. In doing so, the second lifter portion 76b of the switch cam 74 will release the rocker latch 54 from the second notch 56b in the periphery of the control link 48. Then, a second catch edge 78b of the switching cam 74 will abut against a second dog 80b of the control link 48, and force the control link 48 turn about the control link pivot axis 52 in said second direction. Thereby, the drive links 58, 62 will force the propulsion link 23 to turn back about the fluke pivot axis 21, returning the fluke 16 to its forward mode position illustrated in FIGS. 1-2. When the control link 48 has turned back approximately 180° about the control link pivot axis, the rocker latch 54 will engage again with the first notch 56a, thereby engaging the motor 34 with the fluke 16 in the forward mode.

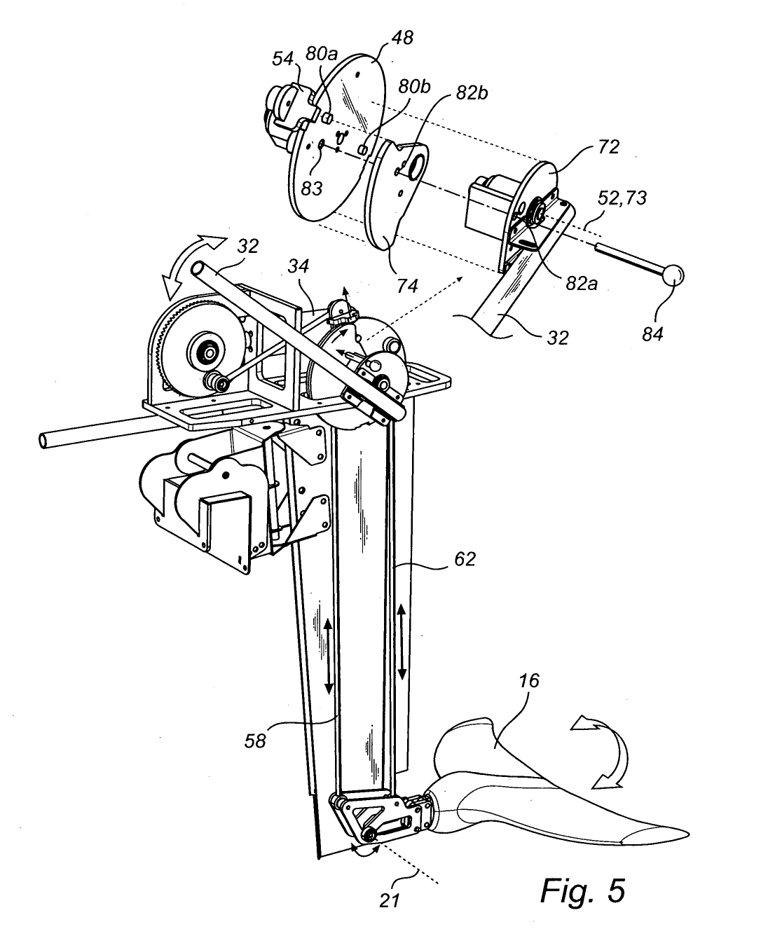

Referring now to FIG. 5, switching the watercraft propulsion device 10 between the motor-powered mode and a manual, “muscle-powered” mode will be described. The outer guide washer 72 is provided with a first circular guide hole 82a. A corresponding second circular guide hole 82b penetrates the switching cam 74. The two guide holes 82a, 82b are aligned with each other. A hand-lever locking hole 83 penetrates the control link 48. The three holes 82a-b, 83 are located at the same radial distance from the control link pivot axis 52, which coincides with the hand-lever assembly pivot axis 73.

By turning the hand-lever assembly 71 in said first direction (indicated with an arrow in FIG. 3) about the hand-lever assembly pivot axis 73 using the hand-lever 32, the first lifter portion 76a of the switching cam 74 will disengage the rocker latch 54 from the first notch 56a in the control link 48 in the same manner as is described above with reference to FIGS. 3-4, when switching from forward to reverse mode. When the first catch edge 78a of the switching cam 74 abuts against the first dog 80a, the three holes 82a-b, 83 all align, and a locking pin 84 may be inserted through the three holes 82a-b, 83, locking the hand-lever assembly 71 to the control link 48. This position is illustrated in FIG. 5. The switching cam 74 will, in this position, prevent the rocker latch 54 from engaging with the first notch 56a, thereby keeping the motor 34 disengaged from the control link 48 and the fluke 16. At the same time, the hand-lever 32 is engaged with the control link 48 by means of the locking pin 84. Thereby, the fluke 16 may be reciprocated about the fluke pivot axis 21 by reciprocating the hand-lever 32 about the hand-lever assembly pivot axis 73. The oscillating motion of the fluke 16 about the fluke pivot axis 21 will result in a forward propulsive thrust of the watercraft propulsion device 10.

It is also possible, although this is not illustrated in detail in the FIGS. 1-5, to set the propulsion device 10 in a reverse, manual mode. This may be obtained by providing the control link 48 with an additional hand-lever locking hole having the same function as the hole 83, but being located such that it aligns with the guide holes 82a-b when the second catch edge 78b of the switching cam 74 abuts against the second dog 80b. Switching the propulsion device 10 to a reverse manual mode is then carried out by turning the hand-lever 32 in the first direction, illustrated hereinbefore with reference to FIG. 3, about the hand-lever assembly pivot axis 73, to a position where it points generally rearward. In this position, the fluke 16 will have been brought to a reverse position in which it extends afore, as is described above with reference to FIGS. 3-4. The hand-lever 32 is thereafter moved back again in the second direction, until the second catch edge 78b of the switching cam 74 abuts against the second dog 80b of the control link 48. By finally inserting the locking pin 84 through the three aligned holes, the propulsion device is set in a reverse manual power mode.

By reciprocating the hand-lever 32 in this position, it is possible to obtain a reverse propulsive thrust of the propulsion device 10.

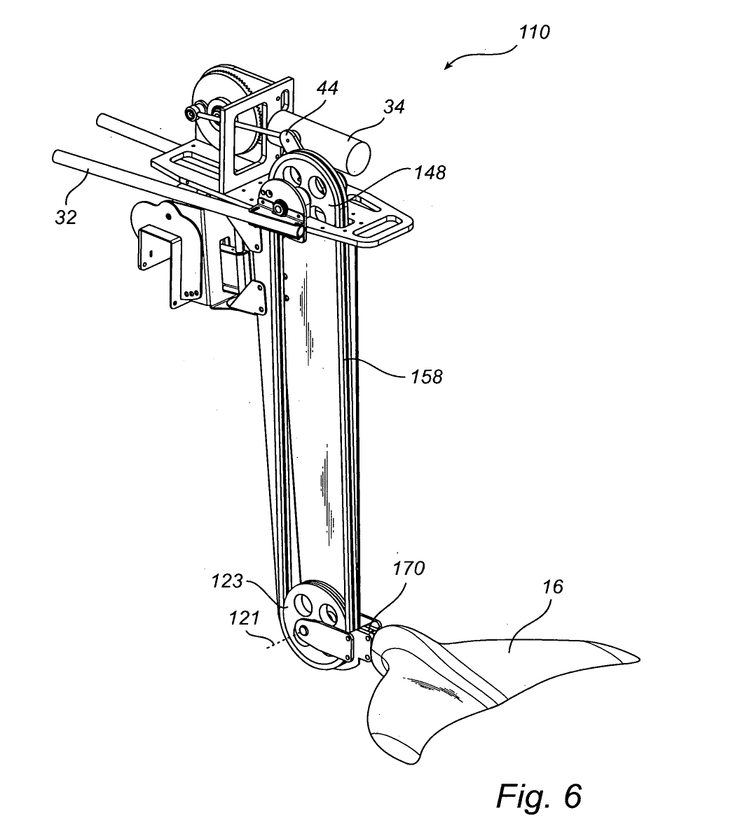

FIG. 6 shows a second embodiment of a watercraft propulsion device 110. The figure illustrates the possibility of achieving the ability to switch between forward/reverse and manual/motor-powered modes in a watercraft propulsion device using transmission means that are different from the first and second drive links 58, 62 that are described above with reference to FIGS. 1-5. The watercraft propulsion device 110 of FIG. 6 comprises a motor 34, an upper control link 148 and a lower propulsion link 123. Even though the two links 148, 123 are both shaped as circular wheels in the illustrated example, a person skilled in the art realizes that they may in fact have many different shapes. A rocker 44, transmitting reciprocating motion from the motor 34, may be releasably engaged with the control link 148, e.g. by means of a rocker locking pin (not shown), arranged to penetrate the rocker 44 and the control link 148.

An endless belt 158 connects the control link 148 to the propulsion link 123, such that an oscillation of the control link 148 about the control link pivot axis will result in an oscillation of the propulsion link 123 about the fluke pivot axis 121.

A fluke 16 is attached, via a fluke bracket 170, to the propulsion link 123 in a non-pivotal manner, such that oscillating the propulsion link 123 about the fluke pivot axis 121 will also result in oscillating the fluke 16 about the fluke pivot axis 121.

Switching from motor-powered to manual mode is performed in a manner similar to what has been described above with reference to FIG. 5, i.e. by

disengaging the motor 34 from the control link 148, e.g. by removing a rocker locking pin (not shown) that penetrates the rocker 44 and the control link 148; and

locking a hand-lever 32 to the control link 148 by means of a hand-lever locking pin (not shown).

Switching from forward to reverse mode is also performed in a manner similar to what has been described above with reference to FIGS. 3-4, i.e. by

engaging the hand-lever 32 with the control link 148, e.g. by inserting a hand-lever locking pin (not shown);

disengaging the motor 34 from the control link 148, e.g. by removing a rocker locking pin (not shown) that penetrates the rocker 44 as well as the control link 148;

turning the control link 148 180° by means of the hand-lever 32 in a first direction (c.f. FIG. 4), thereby turning the fluke 180°;

engaging the motor 34 with the control link 148, e.g. by inserting a rocker locking pin (not shown) through the rocker 44 and the control link 148; and

disengaging the hand-lever 32 from the control link 148 by removing the hand-lever locking pin.

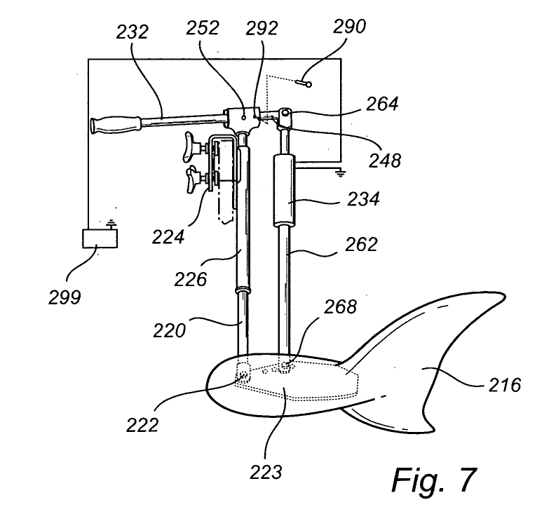

FIG. 7 is a diagrammatic view in perspective of a third embodiment of a watercraft propulsion device 210 in a manual propulsion mode. The watercraft propulsion device 210 shown on the drawing comprises a parallelogram linkage, comprising a support link 220 and a drive link 262 that are interconnected by an upper control link 248 and a lower propulsion link 223. A linear power actuator, such as a linear hydraulic or electric motor 234, is located in the drive link 262, but is not operated in the manual power mode. The electric motor 232 receives its power from a battery 299, which is located in a watercraft (not shown).

The upper control link 248 is forwardly extended by a hand-lever 232 having a handle grip. The lower propulsion link 223 is attached to a flexible propulsion fluke 216, which extends rearwards from the propulsion link 223. The control and propulsion links 248, 223 are interconnected forwardly by the support link 220 and rearwardly by the drive link 262. The support link 220 is a substantially vertical steering shaft, which is rotatably, but non-slidably, supported in a bearing sleeve 226. Bearing sleeve 226 is rigidly connected to a transom bracket 224 for connecting the propulsion device 210 to the transom of a watercraft.

As is further apparent from FIG. 7, the upper end of the support link 220 is connected to the control link 248 in a control link pivot joint 252, and the lower end of the support link 220 is connected to the propulsion link 223 in a fluke pivot joint 222. The upper end of the drive link 262 is connected to the control link 248 in an upper drive link pivot joint 264, and to the propulsion link 123 in a lower drive link pivot joint 268.

A reciprocating motion up and down of the hand-lever 232 will result in a reciprocating motion of the drive link 262 in the vertical direction; also the motor 234 will follow the drive link 262 in this motion. The reciprocating motion of the drive link 262 will cause an oscillating motion of the fluke 216 about the fluke pivot joint 222. Thereby, the propulsion device 210 is capable of propelling itself and the watercraft forward in a surrounding water volume.

It is possible to switch the watercraft propulsion device 210 of FIG. 10 between a manual mode, in which the fluke 216 is oscillated by hand-pumping the hand-lever 232, and a motor-powered mode, in which the fluke 216 can be oscillated by means of the motor 234. This may be done by reconfiguring the control link pivot joint 252 from a pivotal state to a rigid state, e.g. by inserting a locking pin 290 through a hole 292 that penetrates the support link 220 as well as the control link 248, and is located at a distance from the control link pivot joint 252. Having locked the control link 252 in a rigid state, a reciprocating operation of the motor 234 will result in a reciprocating motion up and down of the lower drive link pivot joint 268, and thereby in a propulsive oscillation of the fluke 216.

In summary, the invention relates to a propulsion device for propelling a floating watercraft. The propulsion device comprises a flexible fluke that is pivotal about a substantially horizontal fluke pivot axis, and means for transmitting an oscillatory motion about said fluke pivot axis to said fluke. The propulsion device may be reconfigured between two or more modes or combinations of modes, for example
a manual power mode, in which a hand-lever is mechanically engaged with the fluke for transmitting an oscillatory, propulsive motion to the fluke by means of a reciprocating movement of the hand-lever;
a motor-powered mode, in which a motor is mechanically engaged with the fluke, and the motion of the hand-lever is isolated from any propulsive motion of the fluke about said fluke pivot axis;
a forward mode, in which a main portion of the fluke extends astern of the pivot axis; and
a reverse mode, in which a main portion of the fluke extends afore of the fluke pivot axis.

The invention has mainly been described above with reference to a few embodiments. However, as is readily appreciated by a person skilled in the art, other embodiments than the ones disclosed above are equally possible within the scope of the invention, as defined by the appended patent claims.

For example, it is possible to isolate the motion of the hand-lever 32 from the oscillating motion of the fluke 16 by removing the hand-lever 32 from the propulsion device 10, when operating the propulsion device 10 in a motor-powered mode, and attaching it to the propulsion device 10 again when the propulsion device 10 is to be operated in a manual mode.

And even though the watercraft propulsion device 10 described above with reference to FIGS. 1-5 is adapted to be reconfigured from a forward mode to a reverse mode, and vice versa, by turning the fluke 16 about the fluke pivot axis 21 about which the fluke 16 oscillates when propelling the watercraft 11, it is also possible to switch between forward and reverse modes in many other ways, e.g. by turning the fluke 16 about some other fluke reversal axis.

1. A propulsion device for propelling a floating watercraft, the propulsion device comprising:
a flexible fluke, pivotal about a substantially horizontal fluke pivot-axis; and
a motor to drive the flexible fluke, said propulsion device being settable in
a manual power mode, in which a hand-lever is mechanically engaged with the flexible fluke, to transmit an oscillatory, propulsive motion to the flexible fluke by way of a reciprocating movement of the hand-lever, and
a motor-powered mode, in which the motor is mechanically engaged with the flexible fluke, and the motion of the hand-lever is isolated from any propulsive motion of the flexible fluke about said substantially horizontal fluke pivot axis.

2. The propulsion device according to claim 1, further comprising:
a lower propulsion link from which the flexible fluke extends, and
an upper control link, said lower propulsion link and said upper control link being interconnected by a first vertical link and a second vertical link, said first and second vertical links being connected to said upper control link and said lower propulsion link in pivot joints.

3. The propulsion device according to claim 1, further comprising:
a lower propulsion link, from which the flexible fluke extends, and
an upper control link, said lower propulsion link and said upper control link each including the shape of a wheel, and being interconnected by a drive chain or a drive belt.

4. The propulsion device according to claim 2, wherein said hand-lever is configured to be releasably attached to said upper control link.

5. The propulsion device according to claim 2, wherein at least one of said pivot joints is reconfigurable from a pivotal state to a rigid state.

6. A propulsion device according to claim 1, wherein said propulsion device settable in
a forward mode, in which a main portion of the flexible fluke extends astern of the substantially horizontal fluke pivot axis; and
a reverse mode, in which a main portion of the flexible fluke extends afore of the substantially horizontal fluke pivot axis.

7. A propulsion device for propelling a floating watercraft, the propulsion device comprising:
a flexible fluke, pivotal about a substantially horizontal fluke pivot axis; and
means for transmitting an oscillatory motion about said substantially horizontal fluke pivot axis to said flexible fluke, said propulsion device being settable in
a forward mode, in which a main portion of the flexible fluke exterids astern of the substantially horizontal fluke pivot axis; and
a reverse mode, in which a main portion of the flexible fluke extends afore of the substantially horizontal fluke pivot axis.

8. The propulsion device according to claim 6, wherein the propulsion device is arranged to be reconfigured from said forward mode to said reverse mode by turning the flexible fluke about a substantially horizontal fluke reversal axis.

9. The propulsion device according to claim 8, further comprising:
a lower propulsion link, from which the flexible fluke extends rearwards, and
an upper control link, said lower propulsion link and said upper control link being interconnected by a first vertical link and a second vertical link, said first and second vertical links being connected to said upper control link and said lower propulsion link in pivot joints, wherein the propulsion device is arranged to be reconfigured from said forward mode to said reverse mode by turning said upper control link about a substantially horizontal control link axis, such that the flexible fluke is turned about said substantially horizontal fluke reversal axis.

10. The propulsion device according to claim 9, further comprising a support link, to supports a fluke pivot joint that coincides with said substantially horizontal fluke reversal axis and said substantially horizontal fluke pivot axis.

11. The propulsion device according to claim 7, further comprising a lower propulsion link, from which the flexible fluke extends, and an upper control link, said lower propulsion link and said upper control link each including a shape of a wheel, and being interconnected by a drive chain or a drive belt.

12. The propulsion device according to claim 1, further comprising a transom bracket to removably install the propulsion device to the transom of a floating watercraft.

13. The propulsion device according to claim 3, wherein said hand-lever is configured to be releasably attached to said upper control link.

14. The propulsion device according to claim 6, wherein the propulsion device is arranged to be reconfigured from said forward mode to said reverse mode by turning the flexible fluke about a substantially horizontal fluke reversal axis.

15. The propulsion device according to claim 8, further comprising a lower propulsion link, from which the flexible fluke extends, and an upper control link, said lower propulsion link and said upper control link each including a shape of a wheel, and being interconnected by a drive chain or a drive belt.

16. The propulsion device according to claim 7, further comprising a transom bracket to removably install the propulsion device to the transom of a floating watercraft.
